(19) United States
(12) Patent Application Publication
(10) Pub. No.: US 2007/0094107 A1
(43) Pub. Date: Apr. 26, 2007

(54) Method of evaluating and managing equipment lease portfolios

(76) Inventors: Susan Franklin, Cohasset, MA (US); John Patrick Kirk, Needham, MA (US)

Correspondence Address: DIEDERIKS & WHITELAW, PLC, #301, 12471 Dillingham Square, Woodbridge, VA, 22192, US

(21) Appl. No.: 11/253,566

(22) Filed: Oct. 20, 2005

(51) Int. Cl. G07F 19/00; G07B 17/00

(52) U.S. Cl. 705/30

(57) ABSTRACT

A method of evaluating and managing equipment leases including determining the relative relationship between the lessee and various lessors by reviewing UCC filings and internal company documents to determine the true overall cost of leasing. Additionally, weaknesses on how leases are formed are studied so as to develop a more effective negotiating strategy and alter the strategy in managing leases in the future.

### BACKGROUND OF THE INVENTION

1. Field of the Invention

The present invention pertains to the art of equipment lease analysis and management and, more particularly, provides for a method of evaluating and managing the total lifecycle of equipment leases both on an individual and portfolio basis to allow a lessee to obtain a better understanding of the various leases it has entered and thus manage their leases to a more cost-effective outcome.

2. Discussion of the Prior Art

A large percentage of U.S. companies currently lease some or all of their capital equipment. Generally, they use equipment leasing to preserve operating cash flow and gain access to capital equipment they need to support day-to-day operations. Of the $668 billion spent by businesses domestically on productive assets in the year 2003, $208 billion, or 31 percent, was acquired through leasing.

Various organizations, such as finance companies, banks and independent financial service organizations (referred to as “lessors”), provide lease financing to American businesses (referred to as “lessees”) domestically and internationally. Lessors include large and small organizations some of whom specialize in particular types of equipment or industries and other who finance a wide range of equipment from computers to aircraft. Their services range from solely providing capital, to providing capital along with equipment maintenance, warranties and asset management.

Typically, companies with substantial volumes of leased assets have difficulty properly managing the leasing process and the cost of their leasing arrangements. The leasing process requires management of a significant amount of information pertaining to leased assets. Often, information such as the asset's configuration, location, cost and varying financial and contract terms, including, for example, (i) the commencement and termination dates, (ii) the notification dates and (iii) the conditions regarding the return of leased equipment, may only be recorded in paper contracts, equipment orders, vendor invoices, lessor invoices and reports. In some cases, certain information may be in independent digital medium like spreadsheets, data files and image files. Almost without exception, the governing lease contracts and associated paperwork and digital medium are prepared by the lessor.

Most lessor companies currently manage their leases on a portfolio basis. For example, they usually know and track each item of equipment placed on lease with each lessee over the life of their relationship, the total aggregate value of that equipment, how much rent each lessee has paid and is committed to pay over the life of their relationship, whether or not the lessee usually renews or extends leases and how long, on average, each lease actually lasts as compared to its contracted term and whether the lessee ultimately returns or purchases the leased equipment. Generally, lessors track the total revenue generated by each of its leases and each of its lessee relationships, including the amount of revenue derived from interim rent, base rent, renewal or extended rent, asset purchases, penalties, interest and other charges. This acute economic detail allows lessors to evaluate lessee behavior and assess the overall lease management capabilities of each lessee.

On the other hand, the management of leases by lessee companies tends to be asset-focused and event-driven. An event-driven approach results in lessees managing their leases as individual transactions rather than as a portfolio of related leases or a relationship account for a certain lessor. Lessees tend to view each lease as an individual transaction and form new leases based on equipment criteria like how long the equipment will be used and when the equipment will be delivered. Most lessees enter leases (especially technology leases) with the intention of returning the equipment to the lessor at the end of the base term. Although many lessees estimate an end of lease value when performing a lease versus buy analysis, most lessees believe that they will return the equipment to the lessor at the conclusion of the base term, on time and at no additional cost. In practice, these assumptions are frequently incorrect and lessees often face significant unplanned costs at the conclusion of the base term of their leases.

For many lessees, assumptions regarding the useful life of an asset or management directives like standard replacement cycles often overshadow economic considerations and new leasing decisions are evaluated independent of historic costs (i.e. the total cost of the leasing lifecycle). The particular equipment needs of the lessee and budget management concerns typically drive both new lease and aging lease decisions. For example, for a variety of reasons including the need to support evolving technology requirements or upcoming lease expirations, a lessee may need to acquire a new server. The lessee may evaluate the lease for the new server as an isolated transaction, and not assess the end of lease terms and conditions for the server being replaced or other items of leased equipment related to the server being replaced (i.e. NAS device or tape library), or wider considerations like the corporate long term leasing strategy. As lease contracts generally require the lessee to pay certain penalties for lost equipment, missing parts or its failure to return leased equipment on time in accordance with the terms of the lease, when the old leased server is removed and the new leased server is installed and operational, the lessee may be faced with additional unanticipated costs upon the return of the old leased server.

Based on the above, there is a need in the art to develop a method for evaluating the total cost of leasing, either internally within the lessee's organization or through the use of consulting services designed to help lessees manage leases more effectively.

### SUMMARY OF THE INVENTION

The present invention is directed to a method of evaluating, from a variety of perspectives including, but not limited to, transaction, project, division, equipment type or portfolio, an anticipated cost of leases under consideration by a lessee, an actual cost of a lessee's concluded equipment leases, and a projected cost (on a risk-adjusted basis) of both a lessee's active equipment leases and its potential future equipment leases, either by an analyst in management within a lessee company or, alternatively, on a consulting basis.

Initially, an analyst in management within a lessee company or a consultant for the lessee company may sort through and organize various Uniform Commercial Code (UCC) filings in order to develop an idea of the scope of a particular lessee's equipment lease portfolio. The UCC data, once analyzed, can be used to place the overall relationship between the lessee company and the lessor in context with lessee companies in their peer group and other lessee companies comprising the portfolio of a certain lessor. For example, a lessee company may determine that they are the only client from a particular industry in the portfolio of a certain lessor, or that they are the largest lessee company of that particular lessor, or that they have been over the last year, the most active lessee company (in terms of new business) of a certain lessor.

Next, lease documents obtained from the lessee company are reviewed to obtain a detailed profile of the overall portfolio of all leases executed between the lessee company and each of its lessors. Each lease is examined to determine the actual total cost of leasing for concluded leases and the projected total cost of leasing for active leases. This total cost of leasing analysis takes into consideration all amounts paid or to be paid by the lessee to the lessor over the lifecycle of a particular leased asset. Costs incurred for leases which are not paid to the lessor (i.e. transportation charges, administrative overhead, equipment maintenance or warranty) are excluded for the purposes of determining the lessee's total cost of leasing, however, are included for establishing operational and administrative cost metrics or measurements. For example, prior to the base term of a lease (pre-term), the contract may allow for the assessment of interim rent for periods between equipment delivery and the commencement date of the lease, in addition to other possible fees and charges including, but not limited to, documentation fees, commitment fees, security deposits, advance rents, rate lock fees, and asset management fees. For the base term of the lease, the base rent due and payable is generally stated in the lease contract or is readily calculated using a rate factor printed in the lease contract. During the term of the lease (mid-term) or at the end of the lease, additional charges are frequently incurred by lessee companies. For example, it may be difficult to return equipment (or in some cases all of the equipment on a certain lease) at the end of the lease. The lease may provide for an automatic extension of the lease, or the lessor may assess other penalties for the failure by the lessee company to return all or any of the leased equipment on time, or in the condition required under the lease. Lessees may renew an entire lease or a portion of a lease, and/or purchase some or all of the leased assets from the lessor at the expiration of the lease or at the conclusion of any renewal or extension period. The cost of any such renewal, extension or purchase should be accounted for by the analyst in the total cost of leasing analysis. At times, lessees may upgrade or reconfigure leased equipment, carrying outstanding economic obligations into the obligations associated with a new lease. Additionally, lessees may trade-in equipment in conjunction with the acquisition of new equipment to be leased. In these such circumstances, all rent and other amounts paid under original leases, and the trade-in value (if any) should be included in the total cost analysis of the new lease.

For a portfolio of leases, the economic results of the total cost of leasing analysis are combined with the relationship dynamics between the lessee company and the lessor established through UCC data and interviews with the lessee company. This allows the analyst to identify and rate defects (risk), including defects in the underlying pricing or structure of leases, defects in the governing terms and conditions of leases and defects in the lessees' current lease management process. The lessee company can then address the defects and improve the management process.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 shows a flow chart depicting the method of evaluating and managing equipment leases on a risk-adjusted basis, according to a preferred embodiment of the invention; and

FIG. 2 shows a typical UCC record.

### DETAILED DESCRIPTION OF THE PREFERRED EMBODIMENT

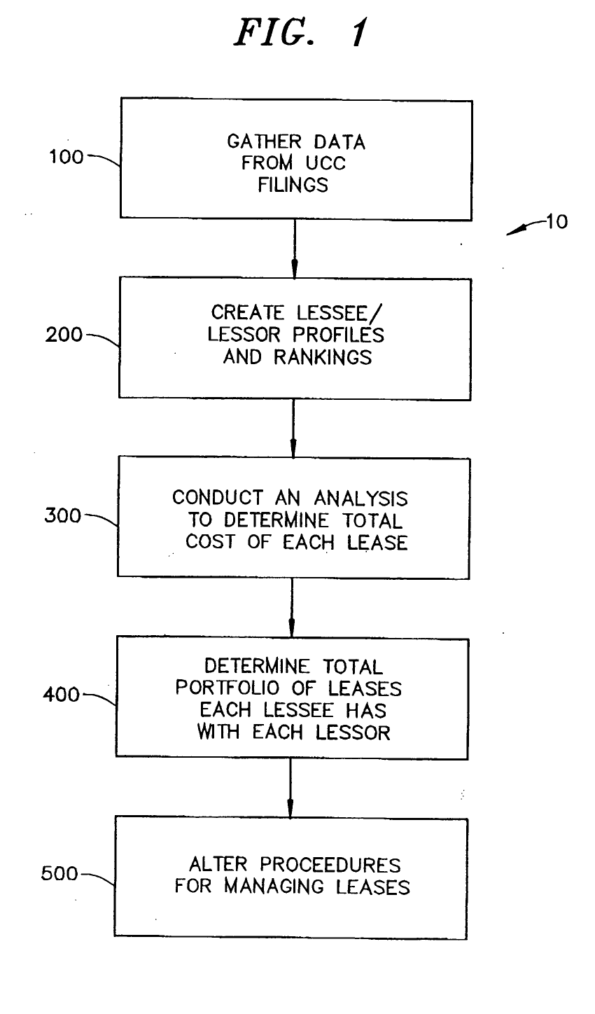

With initial reference to FIG. 1, there is shown the overall method of analyzing and managing equipment lease portfolio according to a preferred embodiment of the invention. The method begins at step 100 wherein data is gathered about the business entities involved with the portfolio from various Uniform Commercial Code (UCC) filings across different states. Next, at step 200, lessee/lessor profiles are created along with the various rankings of how many leases have been executed between each lessee and the various lessors. For a particular lessee, the lessee's files are reviewed and an analysis of each lease is conducted at step 300 to determine the total cost of each lease over its lifecycle and the total aggregate cost of the lessor relationship. Typically in step 400, a comparative analysis of the governing terms and conditions and the portfolio economics for each lessor is prepared to establish effective cost and relationship value. Finally, in step 500, consulting services are delivered to the lessee so that the lessee can better manage its leases and its relationships with its lessors and alter how the leases are formed.

Returning for a moment to step 100, it should be noted that the UCC code is a standard set of rules that govern commercial transactions which have been adopted by several states in various forms. The UCC adopts the “notice filing” approach under which an abbreviated notice may be filed with the state evidencing that a debtor and a secured party intend to engage in a secured transaction using specified collateral as security. An actual security agreement may or may not be executed later. The UCC became effective on Jun. 30, 1996 and applies to transactions entered into and events occurring after that date. Typically, a notice is filed in the state wherein the business entity is registered or, if the organization is unregistered and has more than one place of business, the state where the chief executive office is located or, finally, in the case of an individual sole proprietor, the filing would be in the state where the individual resides. Filing with a state agency is required to perfect a security interest or agricultural lien.

For lease transactions, the UCC filings are addressed in Article 2a of the UCC and are generally recorded at the appropriate state, county and city levels between lessees and lessors to notify the public of the lessor's legal ownership in the leased equipment, and to secure the lessor's interest in the lease and leased equipment. As a result of the UCC, large quantities of records have been filed with each state. These records may be aggregated by sorting the data by state for lessors and lessees and in organizing the filings by the number of filings and their recordation date.

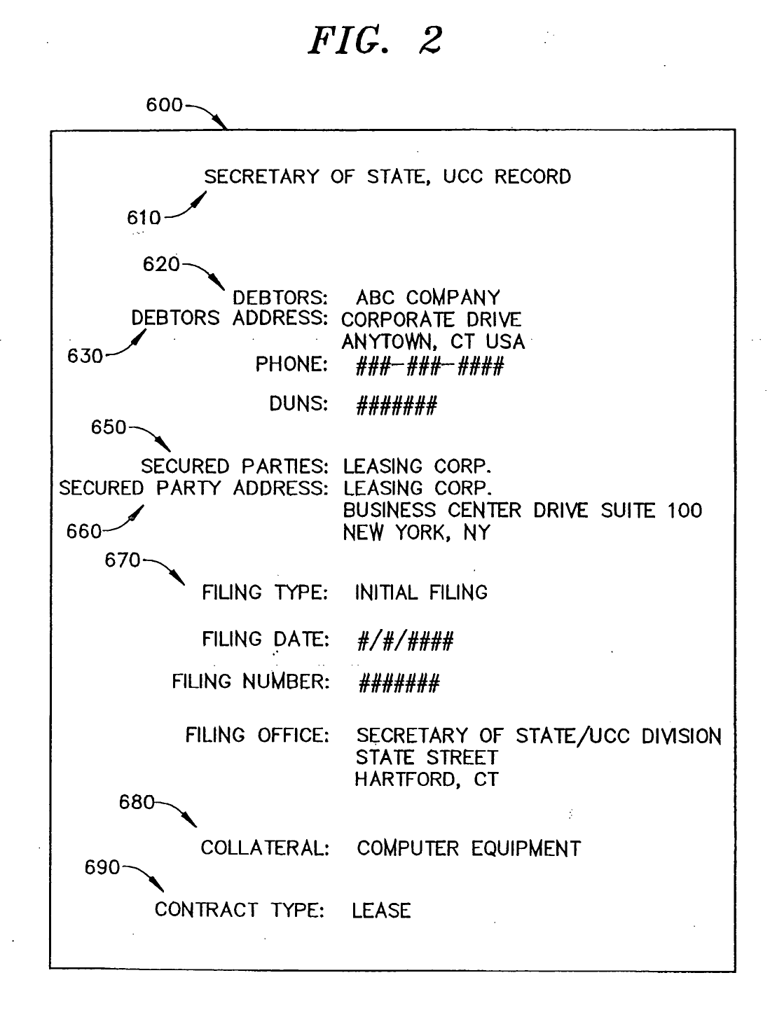

With reference to FIG. 2, this is an example of a raw data record 600 for a lessor in a state. Raw data record 600 includes indication 610 of which state has recorded the UCC data and the government agency responsible for the data, e.g., the Secretary of that State. Additionally, the name of a debtor 620 is included along with a debtor's address 630, its phone number and, typically, its Dun & Bradstreet Number (DUNS). Also listed are secured parties 650 under the party's name along with an address 660. A filing type 670, such as an initial filing, is recorded along with the filing date, filing number and the filing office. Further indicated is a type of collateral 680, such as computer equipment, and a contract type 690, such as a lease. The various UCC filings are then sorted and organized in order to develop a proxy for the scope of the lessee's equipment lease portfolio. Essentially, as shown in step 200 of FIG. 1, the filing data is aggregated and organized to create both a lessee and a lessor profile. The lessee profile ranks the lessee's relationships with lessors by the number of filings and recordation timeline. The lessor profile ranks the lessor's clients by the number of filings and recordation timeline. In each case a geographical summery may be also included. As shown in Table 1, the lessor profile establishes those lessees who have received financing by that particular lessor and sorts the lessees by the number of filings and the recording timeline. A similar table is generated for the lessee profile showing each of their lessors and ranking the lessor relationship by number of filings and recordation timeline.

TABLE 1

| List of Lessor's Clients | Number of UCC Filings |
|---|---|
| ABC Corporation | 525 |
| XYZ Incorporated | 434 |
| General Company | 123 |
| . . . | . . . |

In step 300, the lessee's files are reviewed and analyzed using RACOL™ (Risk Adjusted Cost of Leasing) methods to determine the total cost of leasing for each lease in a lessor portfolio. RACOL™ is a method of analyzing equipment lease data from disparate sources in conjunction with the lessee profile, lessor profile, related lease contracts and other lease records. These materials are used to establish the overall economics of each individual lease or schedule comprising a lessor portfolio, and the aggregate economics, dynamics and relative importance of the portfolio overall. For a lessee, this analysis may be performed on a single lessor portfolio or all lessor portfolios. The analysis generally encompasses all of the leases the lessee executed with each a certain lessor since the inception of their relationship, however if desired, a portfolio may be defined as a portion of all the leases and may be evaluated independently. For example all technology leases or all material handling leases may constitute a portfolio. Indeed a portfolio could contain a single lease.

To establish the lessee's historical cost performance with a particular lessor, and project the future risk inherent in the lessor portfolio, the individual leases analyzed are segregated into two groups (a) concluded leases and (b) active leases. RACOL™ takes into consideration all costs paid and due to be paid under each lease and the timing and amount of the payments, whether for the base term (i.e. base rent), or for periods preceding the base term (pre-term) or for periods arising after the base term such as mid-term and end-of-term. The pre-term costs may include interim rent or stub rent payments, proposal fees, commitment fees, security deposits, rate lock fees and other fees associated with delivery of the equipment or inception of each lease. The mid-term costs may be analyzed by calculating a cost of rewriting active leases into new leases; calculating a cost of upgrading or refreshing equipment subject to a lease; calculating a cost of loss or damage to equipment subject to a lease; and calculating a cost of assigning, subleasing or terminating a lease. The end of term costs include but are not limited to extended rents, renewal rents, restocking fees, equipment repair or other non-compliance costs. In addition to calculating the total cost paid or to be paid by the lessee (i.e. the lessee's “all-in-cost of leasing”), RACOL™ uses this information to derive the lessor's “cash-on-cash” internal rate of return (i.e. lessor yield) and metrics regarding the lease management effectiveness of the lessee.

Table 2 below displays the summarized results of a RACOL™ analysis for just the concluded leases in a lessor portfolio and shows the lessee's historical cost performance (metric) (i.e. the total cost of leasing and the lessee's lease management effectiveness) with that particular lessor. RACOL™ later applies these historical performance metrics to the active leases in the lessor portfolio to determine the potential total cost of leasing (risk) inherent in the remaining portfolio. In addition to calculating both the actual and project cost of leasing for the lessee, the data derived in step 300 is also used to calculate the lessor's internal rate of return (on a cash-on-cash basis) on the concluded leases, the active leases to date and on a risk adjusted basis and finally, the portfolio overall.

TABLE 2
RACOL ANALYSIS - CONCLUDED LEASES WITH LESSOR A

| Lessor | Lessor A | Lessor A | Lessor A | Lessor A | Lessor A |
|---|---|---|---|---|---|
| Lease | B-1 | B-2 | B-3 | B-4 | B-5 |
| Type | Laptop | Laptop | Laptop | Laptop | Laptop |
| Total OEC | 4,486,377 | 370,785 | 685,595 | 496,118 | 500,726 |
| Base Term | 24 | 24 | 24 | 24 | 24 |
| Pre-Term | | | | | |
| Interim Rent | 13,292 | 60,804 | 27,905 | 29,305 | 38,062 |
| Base Term | | | | | |
| Base Rent | 168,419 | 13,919 | 25,648 | 18,455 | 18,622 |
| Total Base Rent | 4,042,046 | 334,062 | 615,555 | 443,887 | 446,928 |
| PV | 83.6% | 83.6% | 83.3% | 83.0% | 82.8% |
| Mid Term | | | | | |
| End of Term | | | | | |
| Extended Rent | 3 | 3 | 3 | 3 | 3 |
| Total Ext Rent | 505,256 | 41,758 | 76,944 | 55,486 | 55,866 |
| Total ALL Rent | 4,560,594 | 436,624 | 720,403 | 528,678 | 540,856 |
| Total End of Term Costs | 852,412 | 81,573 | 164,543 | 124,030 | 100,145 |
| Total All-in Cost | 5,413,005 | 518,157 | 884,946 | 652,707 | 641,002 |
| Potential Cost (Risk) | 1,370,959 | 184,134 | 269,392 | 208,820 | 194,073 |
| NPV | 108.55% | 127.03% | 116.13% | 118.46% | 115.77% |
| IRR | 15.45% | 32.79% | 21.40% | 23.35% | 21.94% |

| | | | | | |
|---|---|---|---|---|---|
| Lessor | Lessor A | Lessor A | Lessor A | | |
| Lease | B-6 | B-7 | B-8 | | |
| Type | Laptop | Laptop | Laptop | | |
| Total OEC | 778,260 | 562,609 | 644,432 | 8,524,922 | |
| Base Term | 24 | 24 | 24 | 24 | |
| Pre-Term | | | | | |
| Interim Rent | 41,572 | 22,366 | 27,147 | 260,452 | 3% |
| Base Term | | | | | |
| Base Rent | 29,186 | 21,109 | 23,920 | 319,318 | |
| Total Base Rent | 700,452 | 506,618 | 574,080 | 7,663,629 | 90% |
| PV | 83.5% | 83.5% | 82.6% | 83.4% | |
| Mid Term | | | | | |
| End of Term | | | | | |
| Extended Rent | 3 | 3 | 3 | 3 | |
| Total Ext Rent | 87,557 | 63,327 | 71,760 | 957,954 | 11% |
| Total ALL Rent | 629,581 | 592,311 | 672,987 | 8,882,034 | 104% |
| Total End of Term Costs | 163,439 | 90,017 | 173,997 | 1,750,155 | 21% |
| Total All-in Cost | 993,020 | 682,328 | 846,984 | 10,632,189 | 125% |
| Potential Cost (Risk) | 292,567 | 175,710 | 292,903 | 2,968,560 | |
| NPV | 115.2% | 109.66% | 115.04% | 109.49% | |
| IRR | 21.03% | 16.82% | 22.59% | 18.45% | |

| | | | | | |
|---|---|---|---|---|---|
| Lessor | Lessor A | Lessor A | Lessor A | Lessor A | Lessor A |
| Lease | A-1 | A-2 | A-3 | A-4 | A-5 |
| Type | Server | Server | Server | Server | Server |
| Total OEC | 111,001 | 444,476 | 181,476 | 366,460 | 385,309 |
| Pre-Term | | | | | |
| Interim Rent | 14,352 | 60,692 | 26,279 | 30,715 | 58,003 |
| Base Term | | | | | |
| Base Term | 30 | 30 | 30 | 30 | 30 |
| Base Rent | 3,651 | 14,626 | 5,980 | 12,055 | 12,691 |
| Total Base Rent | 109,542 | 438,782 | 179,400 | 361,662 | 380,730 |
| PV | 89.8% | 89.8% | 69.9% | 89.8% | 89.9% |
| Mid Term | | | | | |
| End of Term | | | | | |
| Extended Rent | 3 | 3 | 3 | 3 | 3 |
| Total Ext Rent | 10,954 | 43,878 | — | 36,166 | — |
| Total All Rent | 134,848 | 543,352 | 205,679 | 423,543 | 438,733 |
| Total End of Term Costs | 17,760 | 80,006 | 0 | 54,969 | 0 |
| Total All-in Cost | 152,608 | 623,358 | 205,679 | 483,512 | 438,733 |
| Potential Cost (Risk) | 43,066 | 184,576 | 26,279 | 121,850 | 58,003 |
| NPV | 122.76% | 121.02% | 99.66% | 105.61% | 97.54% |
| IRR | 25.53% | 27.07% | 12.38% | 21.18% | 12.94% |

| Lessor | | |
|---|---|---|
| Lease | | |
| Type | | |
| Total OEC | 1,488,721 | |
| Pre-Term | | |
| Interim Rent | 190,040 | 13% |
| Base Term | | |
| Base Term | 30 | |
| Base Rent | 49,004 | |
| Total Base Rent | 1,470,116 | 99% |
| PV | 69.8% | |
| Mid Term | | |
| End of Term | | |
| Extended Rent | 3 | |
| Total Ext Rent | 147,012 | 10% |
| Total All Rent | 1,807,168 | 121% |
| Total End of Term Costs | 233,676 | 16% |
| Total All-in Cost | 2,040,844 | 137% |
| Potential Cost (Risk) | 433,774 | |
| NPV | 106.74% | |
| IRR | 21.31% | |
| Total OEC | 10,013,643 | |
| Total Pre-Term Rent | 450,492 | 4% |
| Total Base Term Rent | 9,133,745 | 91% |
| Total End of | 1,104,965 | 11% |
| Term Rent | | |
| Total ALL Rent | 10,689,202 | 107% |
| Total Mid Term Costs | — | 0% |
| Total End of | 1,983,831 | 20% |
| Term Costs | | |
| Total All-In Cost | 12,673,033 | 127% |
| Potential Cost (Risk) | 3,402,334 | 37% |
| NPV | 106.30% | |
| IRR | 18.82% | |

Table 2 summarizes the RACOL™ analysis for the concluded leases in a portfolio with a certain lessor. The portfolio, comprised of 13 independent leases, had a total original equipment cost (Total OEC) of $10,013,643. The Total OEC is the basis from which rent is derived in each lease. The table lists total base rent which is the aggregate base rent due for the base term (Total Base Rent). For example, for a lease with a base term of 30 months, payable monthly, the base rent is the amount due for each one of the 30 months in the base term and the total base rent is the sum of all 30 base rent payments. In Table 2, the Total Base Rent is $9,133,745. Often, lessees evaluate new leases, and measure the economic effectiveness of leases solely on the Total Base Rent due under a lease. To accurately evaluate current leases and new leases under consideration, evaluation should include the Total Base Rent due under a lease, plus all other costs, including but not limited to additional rent, late fees, penalties or other charges, whether assessed for periods preceding the commencement of the lease (i.e. pre-term), during the base term of the lease (i.e. mid-term), at the conclusion of the base term of the lease or after the return of the equipment (i.e. end of term).

During the lifecycle of a lease several events may occur that affect the total cost of that lease. For example, the lease may be combined or rolled into other leases, the lease may be automatically extended or it may be renewed. In certain cases, extensions may result from the leased equipment being difficult to return. For example, at the end of a lease for a number of computers, the lessee may encounter difficulty retrieving all of the computers from the various employees and in order to return them to the lessor. In such a case, the lease may continue beyond its normal termination date. During this extension period, additional rent must be paid for the continued use of the equipment (or if not in use, simply the failure to return the equipment on time). Similarly, leases may be renewed for an additional fixed term. Under the renewal, additional rent payments become due which should be accounted for. Often, such costs are not incorporated into a lessee's analysis, but are an integral part of a RACOL™ analysis.

Mid-term events like upgrades, co-terminus additions and rolls also occur. When leases are rolled, they are essentially rewritten into new leases, sometimes in conjunction with additional equipment. Rolled rents may dramatically increase the total cost of leasing and often allow, the lessor, to reduce or eliminate its risk in the lease (i.e., the risk of the lessee returning the equipment to the lessor and the lessor having to sell the used equipment in a volatile secondary market) into a fixed credit risk in the form of additional rents to be paid by the lessee. Such a shift presents a material change in the economic relationship between the lessor and lessee and is pivotal to assessing the scope of the lessor/lessee relationship and the determining the actual total cost of leasing.

Historical end of term costs (End of Term) are not often given consideration in a lessee's initial purchase or lease decision. RACOL™ analysis includes end of term costs and utilizes end of term behavior to project potential outcomes under a variety of end of term circumstances. For example, a lessee may need to extend a lease in order to organize the return of all the leased equipment to the lessor. They may be required to pay additional rent, or they may incur return penalties due to lost or damaged leased equipment. These costs can be substantial and should be properly taken into account in order to evaluate the total cost of leasing for the lessee company.

In addition to providing the lessee a detailed understanding of its total cost of leasing (both actual and projected), RACOL™ analysis provides the lessor's cash on cash internal rate of return for concluded leases, and their projected rate of return for active leases at various points in the leasing lifecycle. For example, mid-lease a lessor's rate of return (i.e. yield) for the base rent and interim rent may be 8%. As the base term comes to conclusion, the lessee may fail to provide proper notice resulting in an extension that may increase the lessor's yield to 12%. Finally upon return, non-compliance fees may further increase the lessor's yield to 22%. Referring back to Table 2, the lessor's yield on concluded leases in the portfolio was 18.45% on laptop leases and 21.31% on server leases, for a portfolio yield on concluded leases of 18.82%. The lessor's rate of return shows the lessee how their leasing costs translate into the direct economic benefit realized by their lessor on its investment in their portfolio of leases.

TABLE 3
RACOL PROJECTION - ACTIVE LEASES WITH LESSOR A

| Lessor | Lessor A | Lessor A | Lessor A | Lessor A |
|---|---|---|---|---|
| Lease | B-9 | B-10 | B-11 | B-12 |
| Type | Laptop | Laptop | Laptop | Laptop |
| Total OEC | 2,261,545 | 178,115 | 983,425 | 1,295,666 |
| Pre Term | | | | |
| Interim Rent | 127,344 | 10,030 | 55,192 | 72,493 |
| Base Term | | | | |
| Base Term | 24 | 24 | 24 | 24 |
| Base Rent | 84,896 | 6,687 | 36,795 | 48,328 |
| Total Base Rent | 2,037,507 | 160,479 | 883,076 | 1,159,880 |
| PV | 83.6% | 83.6% | 83.3% | 83.0% |

| | | | | |
|---|---|---|---|---|
| Lessor | Lessor A | Lessor A | | |
| Lease | B-13 | B-14 | | |
| Type | Laptop | Laptop | | |
| Total OEC | 254,811 | 867,439 | 5,841,001 | |
| Pre Term | | | | |
| Interim Rent | 14,217 | 48,808 | 328,084 | 6% |
| Base Term | | | | |
| Base Term | 24 | 24 | 24 | |
| Base Rent | 9,478 | 32,539 | 218,723 | |
| Total Base Rent | 227,477 | 780,924 | 5,249,344 | 90% |
| PV | 82.8% | 83.5% | 83.4% | |

RACOL PROJECTION - USING ACTUAL HISTORICAL PERFORMANCE

| | | | | |
|---|---|---|---|---|
| Mid Term | | | | |
| End of Term | | | | |
| Extended Rent | 3 | 3 | 3 | 3 |
| Total Ext Rent | 254,688 | 20,060 | 110,385 | 144,985 |
| Total ALL Rent | 2,419,540 | 190,569 | 1,048,653 | 1,377,358 |
| Total End of | 474,924 | 37,404 | 206,519 | 272,090 |
| Term Costs | | | | |
| Total All-in Cost | 2,894,464 | 227,973 | 1,255,172 | 1,649,448 |
| Excess Cost (Risk) | 856,957 | 67,494 | 372,096 | 489,567 |
| NPV | 115.50% | 115.51% | 115.18% | 114.88% |
| IRR | 21.38% | 21.38% | 21.11% | 20.86% |

| | | | | |
|---|---|---|---|---|
| Mid Term | | | | |
| End of Term | | | | |
| Extended Rent | 3 | 3 | 3 | |
| Total Ext Rent | 28,435 | 97,616 | 656,168 | 11% |
| Total ALL Rent | 270,129 | 927,347 | 6,233,596 | 107% |
| Total End of | 53,510 | 182,162 | 1,226,610 | 21% |
| Term Costs | | | | |
| Total All-in Cost | 323,639 | 1,109,510 | 7,460,206 | 128% |
| Excess Cost (Risk) | 96,162 | 328,585 | 2,968,560 | |
| NPV | 114.61% | 115.43% | 112.49% | |
| IRR | 20.64% | 21.32% | 21.18% | |

| | | | |
|---|---|---|---|
| Lessor | Lessor A | Lessor A | Lessor A |
| Lease | A-6 | A-7 | A-8 |
| Type | Server | Server | Server |
| Total OEC | 654,025 | 1,065,111 | 461,891 |
| Pre Term | | | |
| Interim Rent | 64,546 | 105,123 | 45,587 |
| Base Term | | | |
| Base Term | 30 | 30 | 30 |
| Base Rent | 21,515 | 35,041 | 15,196 |
| Total Base Rent | 645,464 | 1,051,233 | 455,873 |
| PV | 89.8% | 89.8% | 89.8% |

| | | |
|---|---|---|
| Lessor | | |
| Lease | | |
| Type | | |
| Total OEC | 2,181,027 | |
| Pre Term | | |
| Interim Rent | 215,257 | 10% |
| Base Term | | |
| Base Term | 30 | |
| Base Rent | 71,752 | |
| Total Base Rent | 2,152,569 | 99% |
| PV | 89.8% | |

| | | | |
|---|---|---|---|
| Mid Term | | | |
| End of Term | | | |
| Extended Rent | 2 | 2 | 2 |
| Total Ext Rent | 43,031 | 70,082 | 30,392 |
| Total ALL Rent | 753,041 | 1,226,438 | 531,851 |
| Total End of | 104,644 | 170,418 | 73,903 |
| Term Costs | | | |
| Total All-in Cost | 857,685 | 1,396,856 | 605,754 |
| Excess Cost (Risk) | 212,221 | 345,623 | 149,881 |
| NPV | 117.17% | 113.35% | 112.60% |
| IRR | 21.46% | 21.46% | 21.46% |

| Mid Term | | |
|---|---|---|
| End of Term | | |
| Extended Rent | 3 | |
| Total Ext Rent | 143,505 | 7% |
| Total ALL Rent | 2,511,330 | 115% |
| Total End of | 348,964 | 16% |
| Term Costs | | |
| Total All-in Cost | 2,860,295 | 131% |
| Excess Cost (Risk) | 707,726 | |
| NPV | 114.34% | |
| IRR | 21.46% | |
| Total OEC | 8,022,028 | |
| Total Pre-Term Rent | 543,341 | 7% |
| Total Base Term Rent | 7,401,913 | 92% |
| Total End of Term Rent | 799,673 | 10% |
| Total ALL Rent | 8,744,926 | 109% |
| Total Mid Term Costs | — | 0% |
| Total End of | 1,575,575 | 20% |
| Term Costs | | |
| Total All-in Cost | 3,676,286 | 46% |
| Potential Cost (Risk) | 10,320,501 | 129% |
| NPV | 111.20% | |
| IRR | 20.81% | |

Table 3 above is a summary of a RACOL™ analysis for the active leases remaining in the Lessor A portfolio. This segment of the portfolio is comprised of 9 independent leases, having a total original equipment cost (Total OEC) of $8,055,028. The Total Base Rent is $7,401,913. Applying the historical performance metrics for concluded leases in the Lessor A portfolio derived in Step 300 (see Table 2), the lessee's projected cost of leasing (risk) on the remaining portfolio is estimated to be in excess of $3 million which translates to a lessor yield of 18.82% on an investment that would be characterized as short term.

Based on the comparative RACOL™ findings summarized in Table 4 below, the lessee can assess the relative value of the lessor relationship (benefit vs. cost), quantify its potential future leasing risk with that lessor, identify the primary areas where excess costs arise, and develop strategies to improve their approach to leasing, and reduce or eliminate excess costs.

TABLE 4
RACOL SUMMARY

| | Concluded | Active | Total | % OEC |
|---|---|---|---|---|
| Total OEC | 10,013,643 | 8,022,028 | 18,035,671 | |
| Total Pre Term Rent | 450,492 | 543,341 | 993,833 | 6% |
| Total Base Rent | 9,133,745 | 7,401,913 | 16,535,657 | 92% |
| Total End of Term Rent | 1,104,965 | 799,673 | 1,904,638 | 11% |
| Total ALL Rent | 10,689,202 | 8,744,926 | 19,434,128 | 108% |
| Total Mid Term Costs | — | — | — | 0% |
| Total End of Term Costs | 1,983,831 | 1,575,575 | 3,559,405 | 20% |
| Total All-in Cost | 12,673,033 | 10,320,501 | 22,993,533 | 127% |
| Potential Cost (Risk) | 3,402,334 | 3,676,286 | 7,078,619 | 39% |
| NPV | 106.30% | 111.20% | 108.48% | |
| IRR | 18.82% | 20.81% | 19.70% | |

A RACOL™ analysis goes beyond simply looking at the contract terms. Instead, the analysis includes an almost forensic analysis of exactly what occurred during the course of the lessor relationship to date, and based on that information will likely occur over the remaining term of active leases with that lessor. RACOL™ identifies hidden costs and potential risks and utilizes actual historical performance results, together with actual costs assessed to date, to derive the potential economic outcome for leases remaining in a lessor portfolio (i.e. the active leases), including the amount of excess cost (potential future leasing risk) inherent in the portfolio. Aware of their risk-adjusted cost of leasing, the lessee company can leverage RACOL™ findings to make informed decisions with respect to its portfolio and its lease management process, and take steps to address and improve portfolio and operational defects in order to reduce future potential leasing risk.

A RACOL™ driven lease management process incorporates RACOL™ analysis at each stage of the process. During this process, which is either conducted internally by an analyst in management or externally by a consultant, the lessee in step 500 may institute a new or improved lease management process that incorporates components of RACOL™. A RACOL™ process allows lessees to view leasing from a portfolio (relationship) perspective by capturing the economics of the relationship overtime and tracking their actual cost of leasing and the lessor's internal rate of return. A RACOL™ process positions the lessee to be informed about its leasing and therefore enables the lessee to make informed decisions regarding their leases. A RACOL™ process also allows the lessee to consistently measure leasing costs and trends in leasing costs to determine how leasing benefits or adversely affects its business. A RACOL™ process improves the way lessees assess, structure and manage new leasing activity.

In order to improve lease management several specific steps may be taken. Complete and well organized paper records regarding each lease should be maintained in one place so an equipment description, contract terms and costs of each lease can be readily identified. A complete and up to date tickler file of trigger dates in either paper or digital medium should be maintained to support timely notice and action on each lease. Also complete, well-coded accounts payable records for each particular lease should be maintained to support a ready determination of all payments made with respect to each lease. Further the management process should use both historical costs, operational capabilities and management capabilities to better structure new leases; and using both historical costs, operational capabilities and management capabilities to better structure improved lease management operations, including tools, procedures and personnel. Finally, risk ratings for each lessor portfolio should be compared and used to assess and determine the best approaches to end of term obligations and make informed decisions with respect to new leasing activity with ones current lessors.

The RACOL™ analysis shown in Tables 2, 3 and 4 above has been described in regard to a first time analysis of a company's leasing is activity, such an analysis may be used on an ongoing basis as part of an improved lifecycle lease management process. A RACOL™ process trains lessees to regularly track and evaluate their leases and their lessor relationships on a portfolio basis using both an economic perspective in addition to their traditional asset view. This helps lessees develop an acute awareness of their costs and the yields their lease portfolios generate for their lessor. A RACOL™ management discipline puts lessees in a better position to negotiate terms and understand their actual all in cost of leasing with a particular lessor company. For example, (a) if a lessee is aware, based on UCC profiles and rankings, that it is either the number one historical client or the currently the most active client of a lessor, (b) that RACOL™ analysis established since inception, (i) the total dollars the lessee leased with the lessor, (ii) the total dollars of leases remaining with the lessor, (iii) the actual and projected yields achieved by the lessor, and (iv) the amount of money transmitted to the lessor for rent on its active leases, then the lessee is in a better position to negotiate improved terms and cost-effective lease outcomes with that lessor, as well as improve the effectiveness of its internal lease management process.

Although described with reference to a preferred embodiment of the invention, it should be readily understood that various changes and/or modifications can be made to the invention without departing from the spirit thereof. In general, the invention is only intended to be limited by the scope of the following claims.

I/We claim:

1. A method of evaluating and managing a portfolio of equipment leases comprising:
gathering data about business entities involved with the portfolio;
conducting an analysis to determine both an actual cost and an expected cost on a risk adjusted basis of each lease in the portfolio; and
managing the portfolio, more effectively by using the actual cost and the expected cost of the portfolio to make informed decisions about the leases.

2. The method according to claim 1, wherein gathering data about the business entities involved in the portfolio includes gathering data from UCC filings.

3. The method according to claim 2, further comprising: creating a lessor profile and creating a lessee profile.

4. The method according to claim 3, wherein creating a lessor profile includes listing all of the lessor's clients along with a number of UCC filings for each client and a geographic summary of such of filings.

5. The method according to claim 3, wherein creating a lessee profile includes listing all of the lessors with which the lessee has leases and a number of UCC filings.

6. The method according to claim 3, further comprising determining an overall relationship of the lessor to the lessee based on the UCC filings.

7. The method according to claim 1, wherein conducting an analysis of each lease includes:
analyzing actual and projected pre-term costs of the lease;
analyzing actual and projected base term costs of the lease;
analyzing actual and projected mid-term costs of the lease; and
analyzing actual and projected end of term costs of the lease.

8. The method according to claim 7, wherein analyzing pre term lease costs includes:
calculating a cost of interim or stub rent payments; and
calculating a cost of fees from the group consisting of proposal fees, commitment fees, security deposits, rate lock fees and other fees associated with delivery of the equipment or inception of each lease.

9. The method according to claim 7, wherein analyzing base term lease costs includes:
calculating a cost of rent payments due for a base term of the lease.

10. The method according to claim 7, wherein analyzing mid-term lease costs includes:
calculating a cost of rewriting active leases into new leases;
calculating a cost of upgrading or refreshing equipment subject to a lease;
calculating a cost of loss or damage to equipment subject to a lease; and
calculating a cost of assigning, subleasing or terminating a lease.

11. The method according to claim 7, wherein analyzing end of term lease costs includes:
calculating a cost of extending leases;
calculating a cost of renewing leases;
calculating a cost of returning non-conforming equipment at each lease's conclusion;
calculating a cost of loss or damage to equipment subject to return;
calculating a cost of failure to return equipment on time; and
calculating a cost of restocking, asset management or other end of lease fees associated with the equipment.

12. The method according to claim 1, wherein conducting an analysis includes:
analyzing concluded leases in the portfolio by calculating for each concluded lease in the portfolio, a cost and timing of pre-term costs, a cost and timing of base term costs, a cost and timing of mid-term lease costs, and a cost and timing of end of lease costs to develop an actual all-in-cost of leasing and
using the actual all-in-cost of leasing based on concluded leases to project a potential leasing cost and a potential leasing risk of active leases.

13. The method according to claim 12, wherein the actual all-in-cost of leasing based on concluded leases is used to project potential leasing costs and potential leasing risk of new leases in the future.

14. The method according to claim 1, wherein managing leases more effectively includes:
maintaining complete and well organized paper records regarding each lease in a single place so an equipment description, contract terms and costs of each lease can be readily identified;
maintaining a complete and current tickler file of trigger dates in either paper or digital medium to support timely notice and action on each lease; and
maintaining complete and well coded accounts payable records for a particular lease to support a ready determination of all payments made with respect to each lease.

15. The method according to claim 1, wherein managing leases more effectively includes:
negotiating lease conclusions based on a relative importance of the lessor and lessee to one another.

16. The method according to claim 1, wherein managing leases more effectively includes:
renegotiating lease obligations based on a relative importance of the lessor and lessee to one another.

17. The method according to claim 1, wherein managing leases more effectively includes:
taking all costs into account when evaluating mid-term lease options; and
taking all costs into account when evaluating end of term options.

18. The method according to claim 1, wherein managing leases more effectively includes:
using RACOL™ results to risk rate lessor portfolios and compare the risk ratings of each lessor portfolio to other lessor portfolios; and
assessing a lessee's risk ratings comparatively with other lessees in its peer group.

19. The method according to claim 1, wherein managing leases more effectively includes:
using both historical costs, operational capabilities and management capabilities to better structure new leases; and
using historical costs, operational capabilities and management capabilities to better structure improved lease management operations, including tools, procedures and personnel.
